(19) United States
(12) Patent Application Publication
(10) Pub. No.: US 2012/0246342 A1
(43) Pub. Date: Sep. 27, 2012

(54) SEQUENCE CONVERSION DEVICE

(75) Inventors: Shu Murayama, Tokyo (JP); Shinji Akatsu, Tokyo (JP)

(73) Assignee: MITSUBISHI ELECTRIC CORPORATION, Tokyo (JP)

(21) Appl. No.: 13/514,457

(22) PCT Filed: Sep. 15, 2010
(86) PCT No.: PCT/JP2010/005628

§ 371 Date: Jun. 7, 2012

(30) Foreign Application Priority Data
Dec. 7, 2009 (JP) 2009-277568

(51) Int. Cl. G06F 15/16

(52) U.S. Cl. 709/246

(57) ABSTRACT

An analysis unit extracts conditions for branching in a sequence from sequence data recorded in a recording unit. A condition setting unit presents the result of the condition extraction performed by the analysis unit to the user, accepts a condition setting which the user inputs in response to the presentation of the condition extraction result, and outputs a description of the condition setting as condition setting information to a reconstruction unit. The reconstruction unit reconstructs and outputs the sequence data according to the condition setting information from the condition setting unit, and outputs the sequence data reconstructed thereby as a simplified sequence.

### FIELD OF THE INVENTION

The present invention relates to a sequence conversion device which, when there exists a sequence, such as communications between devices connected to a network, converts a communication sequence which is specification data about the specifications of the sequence into a simplified sequence available for testing or the like.

### BACKBROUND OF THE INVENTION

In a communication apparatus used with being connected to a network, and in software in which a plurality of communication processes run asynchronously, the communication apparatus and the communication processes need to run according to each of various communication sequences, respectively. To this end, all communication sequences with which the communication apparatus and the communication processes should comply are defined in the design phase of the communication apparatus, and the communication apparatus and the communication processes are developed in such a way as to satisfy all the communication sequences. In the testing phase of the communication apparatus, whether the communication apparatus and the communication processes operate according to each of the communication sequences is checked to see.

As one of definition methods of defining a communication sequence, there is a “sequence diagram”. For example, according to an MSC (Message Sequence Chart) which is the international standards (ITU-T Z.120) of a method of expressing a sequence diagram, a complicated expression, such as a description of a conditional branch or a reference to another sequence, is possible, and an MSC is useful for the descriptions of the specifications in the design phase.

On the other hand, when checking to see whether the communication apparatus and the communication processes run according to the specifications in the testing stage, the user needs to perform a complicated interpreting operation satisfying test conditions, such as understanding of a method of describing the specifications, and a reference to other files. To solve this problem, as a sequence diagram creation device for creating a sequence which is easy for the user to understand, there has been provided a sequence diagram creation device as described in patent reference 1, for example. This sequence diagram creation device is aimed to eliminate the difficulty of reading a sequence diagram when software which should be evaluated has a large scale and a huge number of processes are included in the software, and a message is intricately exchanged between processes.

### RELATED ART DOCUMENT

Patent reference

Patent reference 1: Japanese Unexamined Patent Application Publication No. 2007-41638

A problem with the conventional sequence diagram creation device is, however, that because the conventional sequence diagram creation device mainly pays its attention to increase in the number of communication processes, and is specialized in eliminating communication processes unnecessary for the user, the conventional sequence diagram creation device cannot remove the complexity resulting from a conditional branch, a reference to another sequence diagram, and so on which appear in a communication sequence.

The present invention is made in order to solve the above-mentioned problem, and it is therefore an object of the present invention to provide a sequence conversion device which can reduce the time and effort required to interpret a sequence diagram.

### SUMMARY OF THE INVENTION

In accordance with the present invention, there is provided a sequence conversion device including: an analysis unit for extracting conditions for branching in a sequence from sequence data; a condition setting unit for presenting a result of the condition extraction performed by the analysis unit and accepting a condition setting which a user inputs in response to the presentation of the condition extraction result, and for outputting a description of the condition setting as condition setting information; and a reconstruction unit for reconstructing and outputting the sequence data according to the condition setting information from the condition setting unit. Therefore, the sequence conversion device can reduce the time and effort required to interpret a sequence diagram.

### BRIEF DESCRIPTION OF THE FIGURES

FIG. 1 is a configuration diagram showing a sequence conversion device in accordance with Embodiment 1 of the present invention;

FIG. 2 is an explanatory drawing of an input sequence and an output sequence of the sequence conversion device in accordance with Embodiment 1 of the present invention;

FIG. 3 is a configuration diagram showing a sequence conversion device in accordance with Embodiment 2 of the present invention;

FIG. 4 is a configuration diagram showing a sequence conversion device in accordance with Embodiment 3 of the present invention;

FIG. 5 is an explanatory drawing showing an example of an input/output sequence of the sequence conversion device in accordance with Embodiment 3 of the present invention;

FIG. 6 is an explanatory drawing of an output sequence of the sequence conversion device in accordance with Embodiment 3 of the present invention;

FIG. 7 is a configuration diagram showing a sequence conversion device in accordance with Embodiment 4 of the present invention;

FIG. 8 is a configuration diagram showing a sequence conversion device in accordance with Embodiment 5 of the present invention;

FIG. 9 is a configuration diagram showing a sequence conversion device in accordance with Embodiment 6 of the present invention; and

FIG. 10 is a configuration diagram showing a sequence conversion device in accordance with Embodiment 7 of the present invention.

### EMBODIMENTS OF THE INVENTION

Hereafter, in order to explain this invention in greater detail, the preferred embodiments of the present invention will be described with reference to the accompanying drawings.

### Embodiment 1

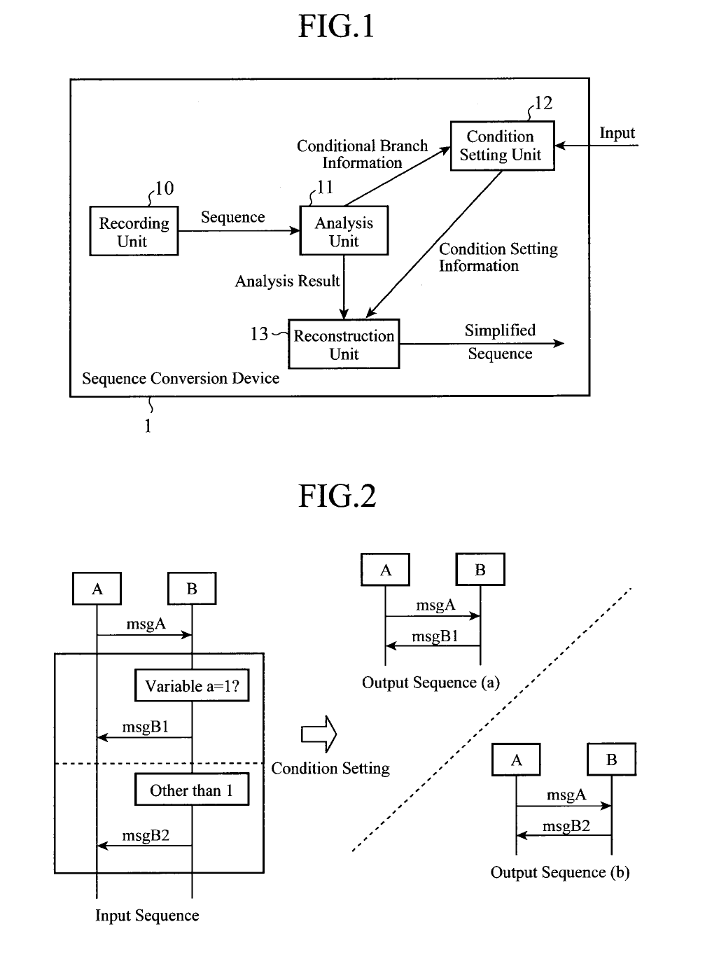

FIG. 1 is a block diagram of a sequence conversion device 1 in accordance with Embodiment 1 of the present invention.

The sequence conversion device 1 shown in FIG. 1 is provided with a recording unit 10, an analysis unit 11, a condition setting unit 12, and a reconstruction unit 13. The recording unit 10 is a storage unit which consists of a hard disk, a memory, or the like for holding sequence data. The analysis unit 11 is a functional unit for sending the result of analysis of sequence data read from the recording unit 10 to the reconstruction unit 13, and for extracting conditions for branching in the sequence from the sequence data, and outputting the result of the extraction of the conditions as conditional branch information. The condition setting unit 12 is a functional unit for presenting the condition extraction result to a not-shown display according to the conditional branch information from the analysis unit 11, and for, when a user makes a selection of a condition in response to the presentation of the condition extraction result, outputting a description of the condition as condition setting information. The reconstruction section 13 is a functional unit for reconstructing and outputting sequence data according to both the sequence data from the analyzer 11 and the condition setting information from the condition setting unit 12.

The sequence conversion device 1 is implemented using a computer, and the analysis units 11, the condition setting unit 12, and the reconstruction unit 13 can consist of pieces of software respectively corresponding to their functions, and hardware including a CPU and a memory for carrying out the pieces of software, or can consist of hardware for exclusive use.

Next, the operation of the sequence conversion device 1 in accordance with Embodiment 1 will be explained.

A plurality of sequence data each of which is created in the design phase of a system and each of which describes a sequence diagram by using an expressing method determined on the system in advance are registered in the recording unit 10, and sequence data which a user selects in order to refer to the sequence data for testing or the like from the plurality of sequence data is inputted to the analysis unit 11. The analysis unit 11 has a function of analyzing the expressing method which the sequence data uses, and extracts pieces of conditional branch information used by the sequence data and sends the pieces of conditional branch information to the condition setting unit 12.

The condition setting unit 12 presents each of the pieces of conditional branch information to the user by using a means, e.g. a display of the pieces of conditional branch information. The user then checks the contents of each of the pieces of conditional branch information and makes a selection of a desired condition, so that condition setting information is determined. For example, when conditional branch information showing “variable a has a value of 1 or a value other than 1” is shown, and the user then selects the following choice: “variable a=1”, this selected choice is defined as condition setting information. The user makes this selection of a condition by using an input device, such as a mouse or a keyboard.

The sequence data analyzed by the analysis unit 11 and the condition setting information inputted by the condition setting unit 12 are inputted to the reconstruction unit 13, and the reconstruction unit 13 reconstructs the analyzed sequence data according to the condition setting information, and outputs the sequence data reconstructed thereby as a simplified sequence.

FIG. 2 is an explanatory drawing of an input sequence and an output sequence.

In the example shown in the figure, the “input sequence” shown on a left side of the figure is inputted to the analysis unit 11, and the “output sequence (a)” shown on a right side of the figure is outputted from the reconstruction unit 13. According to this expressing method, a box which is divided into two portions by a dashed line shows an example in which the sequence works in a different way according to a condition. When the condition of “variable a=1” is satisfied, the upper portion, i.e. “msgB1” is transmitted from B to A, whereas when the condition of “variable a=1” is not satisfied, the lower portion, i.e. “msgB2” is transmitted from B to A, as shown in the example.

In this embodiment, as mentioned above, assuming that “variable a=1” is inputted to the condition setting unit 12 and “variable a=1” is provided to this condition setting unit as the condition setting information, the reconstruction unit reconstructs a sequence in which the lower one of the portions into which the input sequence is divided by the dashed line is removed from the input sequence to output the output sequence (a) as a simplified sequence.

As previously explained, because the sequence conversion device in accordance with Embodiment 1 includes the analysis unit 11 for extracting conditions for branching in a sequence from sequence data, the condition setting unit 12 for presenting the result of the extraction of the conditions by the analysis unit 11 and accepting a condition setting which the user inputs in response to the presentation of the condition extraction result, and for outputting a description of the condition setting as condition setting information, and the reconstruction unit 13 for reconstructing and outputting the sequence data according to the condition setting information from the condition setting unit 12, the sequence conversion device enables the user to easily understand the sequence and to easily check to see a description of the design of a communication apparatus and communication processes performed by software. Further, in the testing stage of the communication apparatus and the communication processes performed by the software, the sequence conversion device enables the user to easily check to see whether the communication apparatus and the software operate according to the sequence.

### Embodiment 2

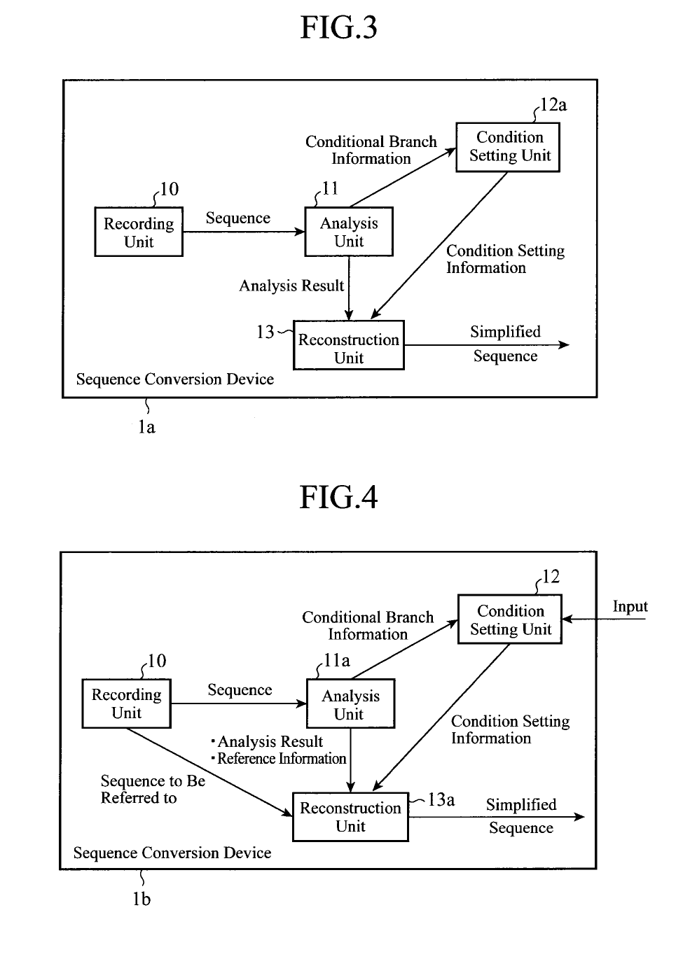

FIG. 3 is a block diagram of a sequence conversion device 1a in accordance with Embodiment 2.

The sequence conversion device 1a in accordance with Embodiment 2 differs from the sequence conversion device 1 in accordance with Embodiment 1 in that a condition setting unit 12a sends plural pieces of condition setting information in a case of making a conditional branch to a reconstruction unit 13 not according to an instruction from the user, but according to conditional branch information inputted from an analysis unit 11. Because the other components of the sequence conversion device are the same as those in accordance with Embodiment 1 shown in FIG. 1, the explanation of the components will be omitted hereafter.

Next, the operation of the sequence conversion device 1a in accordance with Embodiment 2 will be explained.

After acquiring conditional branch information from the analysis unit 11, the condition setting unit 12a notifies plural pieces of condition setting information in a case of making each conditional branch to a reconstruction unit 13, instead of not presenting the plural pieces of condition setting information to the user and not accepting a request to set a condition. The reconstruction unit 13 reconstructs a sequence individually for each of a plurality of condition settings to create simplified sequences.

For example, in a case of an input sequence shown on a left-hand side of FIG. 2, the condition setting unit 12a inputs both “variable a=1” and “variable a≠1” to the reconstruction unit 13 as pieces of condition setting information. As a result, the reconstruction unit 13 sequentially reconstructs sequences for the two conditions, and outputs both the output sequences (a) and (b) shown on a right-hand side of FIG. 2.

As mentioned above, because the sequence conversion device in accordance with Embodiment 2 includes the analysis unit 11 for extracting conditions for branching in a sequence from sequence data, the condition setting unit 12a for outputting, as plural pieces of condition setting information, descriptions of a plurality of condition settings in a case of making a conditional branch according to the result of the extraction of the conditions by the analysis unit 11, and the reconstruction unit 13 for reconstructing and outputting the sequence data according to the plural pieces of condition setting information from the condition setting unit 12a, the sequence conversion device can perform a condition setting process without prompting the user to input a condition setting, and can therefore reduce the frequency with which the user misses making a condition setting. Further, because the sequence conversion device eliminates the necessity for the user to repeatedly perform a plurality of condition setting operations, the sequence conversion device can reduce the time required to create simplified sequences.

### Embodiment 3

FIG. 4 is a block diagram showing a sequence conversion device 1b in accordance with Embodiment 3.

The sequence conversion device 1b in accordance with Embodiment 3 differs from the sequence conversion device 1 in accordance with Embodiment 1 in that an analysis unit 11a extracts reference information about a reference from a sequence to another sequence, and a reconstruction unit 13a acquires a sequence to be referred to from a recording unit 10 according to this reference information, and reconstructs sequence data by using this sequence to be referred to. Because the other components of the sequence conversion device are the same as those in accordance with Embodiment 1 shown in FIG. 1, the explanation of the components will be omitted hereafter.

Next, the operation of the sequence conversion device lb in accordance with Embodiment 3 will be explained.

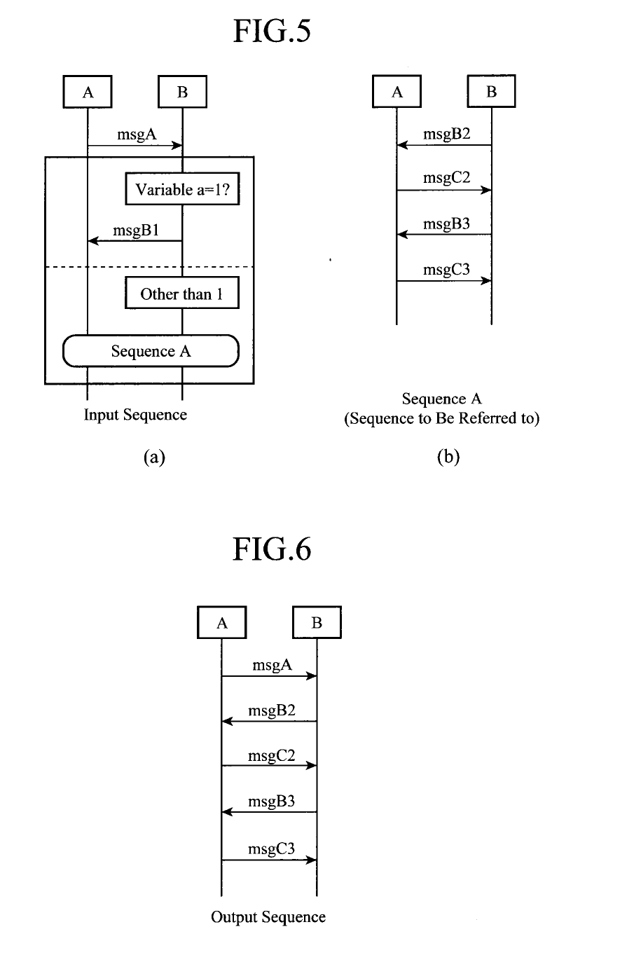

FIG. 5 shows a brief example of input and output sequences in the sequence conversion device in accordance with Embodiment 3, and shows an example of reconstruction of a sequence using reference information. Referring to FIG. 5, a sequence A shown in (b) is referred to from the lowermost part of the input sequence shown in (a). FIG. 6 shows a sequence outputted from the reconstruction unit 13a in accordance with Embodiment 3.

Sequence data acquired from the recording unit 10 is analyzed by the analysis unit 11a, like in the case of Embodiment 1. At this time, reference information is also extracted in addition to conditional branch information. In the example of FIG. 5, the reconstruction unit 13a is notified that the sequence A is referred to.

The reconstruction unit 13a acquires the sequence A from the recording unit 10 as a sequence to be referred to according to this reference information. In this case, because the sequence does not have any portion which refers to another sequence when “variable a=1” is selected by a condition setting unit 12, like in the case of the example shown in Embodiment 1, the output sequence (a) shown in FIG. 2 is outputted as a simplified sequence, whereas when “variable a≠1” is selected by the condition setting unit 12, the portion which refers to the sequence A is enabled, and the reconstruction unit 13a outputs such a simplified sequence as shown in FIG. 6.

Although in Embodiment 3 the example in which this embodiment is applied to the structure in accordance with Embodiment 1 is explained, this embodiment can be alternatively applied to the structure in accordance with Embodiment 2, and, in this case, both the output sequence (a) shown in FIG. 2 and the output sequence shown in FIG. 6 are outputted as simplified sequences.

As mentioned above, in the sequence conversion device in accordance with Embodiment 3, when a sequence to be referred to is included in the sequence, the analysis unit 11a outputs reference information showing that the sequence includes the sequence to be referred, and the reconstruction unit 13a reconstructs sequence data according to this reference information. Therefore, the sequence conversion device eliminates the necessity for the user to check to see a plurality of sequences simultaneously, and enables the user to easily understand the sequence and easily check a description of the design of a communication apparatus and communication processes performed by software. Further, in the testing stage of the communication apparatus and the communication processes performed by the software, the sequence conversion device enables the user to easily check to see whether the communication apparatus and the software operate according to the sequence.

### Embodiment 4

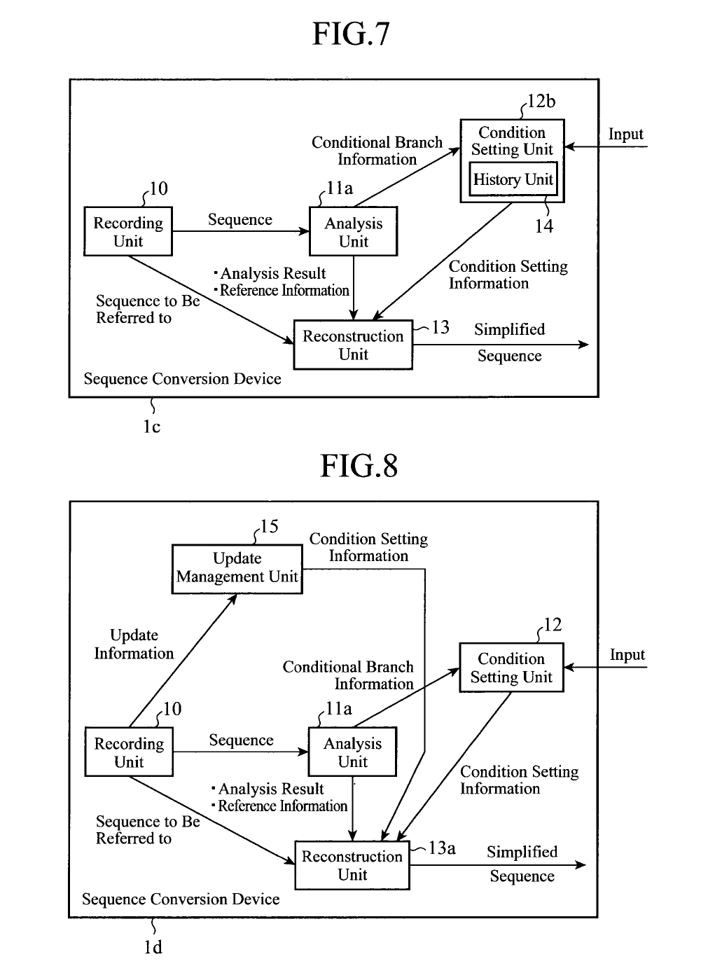

FIG. 7 is a block diagram showing a sequence conversion device 1c in accordance with Embodiment 4.

The sequence conversion device 1c in accordance with Embodiment 4 differs from the sequence conversion device 1b in accordance with Embodiment 3 in that a condition setting unit 12b includes a history unit 14, and carries out presentation to the user by using history information stored in the history unit 14. More specifically, the history unit 14 is a storage unit for holding a history of the results of inputs done by the user, and the condition setting unit 12b is constructed in such a way as to refer to the history unit 14 when acquiring conditional branch information from an analysis unit 11a, and present history information to the user. For example, when there is a conditional branch which has not been selected previously, the condition setting unit 12b presents information about this conditional branch to the user. Because the other components of the sequence conversion device are the same as those in accordance with Embodiment 3, the explanation of the components will be omitted hereafter.

Next, the operation of the sequence conversion device 1c in accordance with Embodiment 4 will be explained.

When presenting information about a conditional branch to the user and accepting an input of a condition setting after acquiring conditional branch information from the analysis unit 11a, the condition setting unit 12b records the result of the input in the history unit 14. While operations including up to an operation of outputting a simplified sequence which the sequence conversion device performs after the recording are the same as those in accordance with Embodiment 3, the sequence conversion device operates in a different way when the same sequence is inputted again.

More specifically, when the same sequence as that which has been inputted previously is inputted to the analysis unit 11a and the same conditional branch information is inputted to the condition setting unit 12b, the condition setting unit 12b refers to the history unit 14 and presents a yet-to-be-set condition to the user. For example, assuming that the user selects “variable a=1” when the user performs the selecting operation for the first time for the following condition shown in Embodiment 1:“variable a has a value of 1 or a value other than 1”, the condition setting unit presents information showing that “variable a≠1” has not been selected yet or “variable a=1” has been selected to the user when the user performs the selecting operation for a second or subsequent time.

Instead of the condition setting unit 12b, the reconstruction unit 13 can refer to the history unit 14. When referring to the history unit 14, the reconstruction unit 13 records condition setting information from the condition setting unit 12b in the history unit 14. When then receiving condition setting information from the condition setting unit 12b, the reconstruction unit refers to the history unit 14, and, when information matching the condition setting information notified from the condition setting unit 12b is recorded in the history unit, the reconstruction unit does not create any simplified sequence. In contrast, when no information matching the condition setting information is recorded in the history unit, the reconstruction unit reconstructs sequence data corresponding to the condition setting information to create a simplified sequence.

As mentioned above, in the sequence conversion device in accordance with Embodiment 4, the history unit 14 for storing the result of a condition setting made for the result of the extraction of conditions for an arbitrary sequence is disposed, and the condition setting unit 12b refers to the history unit 14 when receiving the result of the extraction of conditions for a specific sequence from the analysis unit 11a, and, when the result of a condition setting made for the specific sequence is recorded in the history unit, presents a description of the recorded condition setting result to the user. Therefore, by, for example, presenting a yet-to-be-set condition to the user, the sequence conversion device can reduce the frequency with which the user misses making a condition setting.

Further, in the sequence conversion device in accordance with Embodiment 4, the history unit for storing condition setting information from the condition setting unit 12b is disposed and, when receiving specific condition setting information from the condition setting unit 12b, the reconstruction unit 13 refers to the history unit and determines whether condition setting information matching the specific condition setting information exists in the history unit, and reconstructs sequence data corresponding to the specific condition setting information only when no condition setting information matching the specific condition setting information exists in the history unit. Therefore, the sequence conversion device can suppress the creation of a redundant simplified sequence.

### Embodiment 5

FIG. 8 is a block diagram showing a sequence conversion device 1d in accordance with Embodiment 5.

The sequence conversion device 1d in accordance with Embodiment 5 differs from the sequence conversion device 1b in accordance with Embodiment 3 in that an update management unit 15 is newly added. This update management unit 15 manages the update state of a sequence, and, when there is an update in the sequence, sends condition setting information which the update management unit generates from a difference caused by the update to a reconstruction unit 13a, and the reconstruction unit 13a reconstructs sequence data according to this condition setting information. The other components of the sequence conversion device are the same as those in accordance with Embodiment 3.

Next, the operation of the sequence conversion device in accordance with Embodiment 5 will be explained. When a sequence recorded in a recording unit 10 is updated, information about the update is notified to the update management unit 15. The update management unit 15 records information showing what part of which sequence is updated therein. The update management unit 15 also analyzes what type of condition setting is to be made to cause a simplified sequence to have the updated part, and outputs appropriate condition setting information to the reconstruction unit 13a.

For example, a case in which an input sequence shown on a left side of FIG. 2 is updated to an input sequence shown in FIG. 5(a) in the recording unit 10 will be examined. In this case, the update management unit 15 detects the difference between both the sequences, and determines that a difference appears between simplified sequences when “variable a≠1” is selected as condition setting information, and notifies the contents of the condition setting information to the reconstruction unit 13a. The reconstruction unit 13a creates an output sequence shown in FIG. 6 as a simplified sequence according to the descriptions.

Further, there is a case in which the condition setting unit 12 outputs condition setting information to the reconstruction unit 13a according to the result of a selection made by the user, and the reconstruction unit outputs a simplified sequence, like in the case of Embodiment 1. In addition, the condition setting unit 12 can output plural pieces of condition setting information to the reconstruction unit 13a, and the reconstruction unit 13a can output a plurality of simplified sequences, like in the case of Embodiment 2.

As mentioned above, in the sequence conversion device 1d in accordance with Embodiment 5, the update management unit 15 for managing the update state of a sequence and, when there is an update in the sequence, sending condition setting information which the update management unit generates from a difference caused by the update is disposed, and the reconstruction unit 13a reconstructs sequence data according to the condition setting information. Therefore, in the testing stage of a communication apparatus and communication processes performed by software, the sequence conversion device enables the user to easily check to see whether the communication apparatus and the software operate according to the changed sequence.

### Embodiment 6.

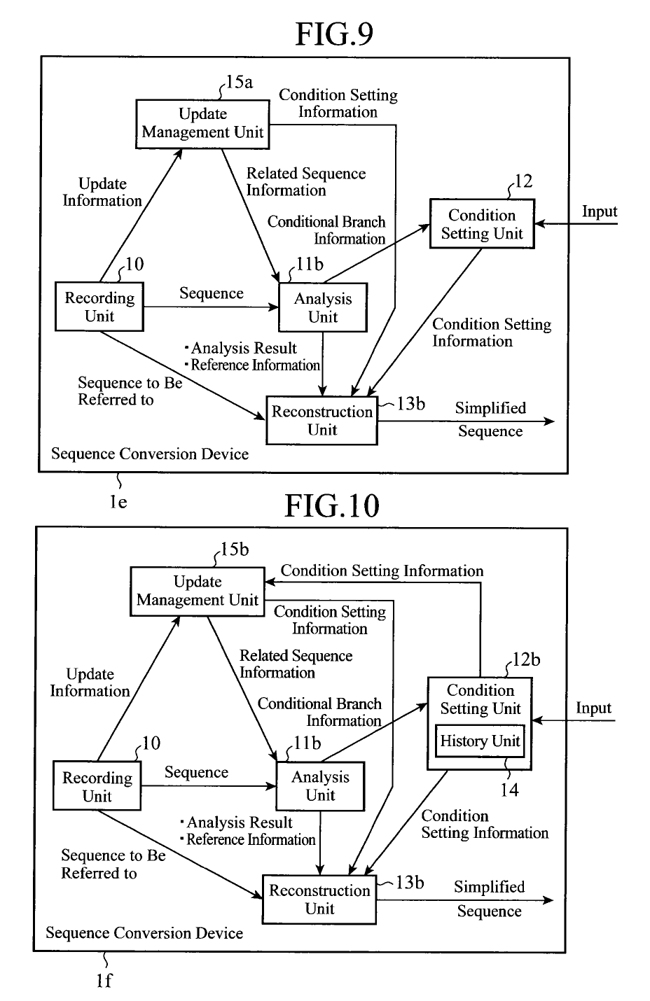

FIG. 9 is a block diagram showing a sequence conversion device 1e in accordance with Embodiment 6.

The sequence conversion device 1e in accordance with Embodiment 6 differs from the sequence conversion device 1d in accordance with Embodiment 5 in that a notification of related sequence information from an update management unit 15a to an analysis unit 11b is newly added. More specifically, the update management unit 15a manages the update state of a sequence, and, when there is an update in the sequence, sends condition setting information which the update management unit generates from a difference caused by the update and, when the sequence updated is a sequence to be referred to, also outputs a sequence which refers to the reference sequence as related sequence information. Further, the analysis unit 11b outputs reference information to a reconstruction unit 13b according to the related sequence information, and the reconstruction unit 13b reconstructs sequence data according to this reference information and condition setting information outputted from the update management unit 15a. The other components of the sequence conversion device are the same as those in accordance with Embodiment 5.

Next, the operation of the sequence conversion device 1e in accordance with Embodiment 6 will be explained. When a sequence recorded in a recording unit 10 is updated, information about the update is notified to the update management unit 15a. When the sequence updated is a sequence to be referred to (a sequence which is referred to by another sequence), the update management unit 15a notifies a list of the sequence to the analysis unit 11b as related sequence information. The analysis unit 11b sequentially acquires sequences from the recording unit 10 according to the contents of the related sequence information, and analyzes the sequences. After that, the sequence conversion device creates a simplified sequence, like those in accordance with the other embodiments.

For example, when a sequence A shown in FIG. 5(b) is updated in the recording unit 10, an input sequence shown in FIG. 5(a) which refers to the sequence is notified to the analysis unit 11b as related sequence information. After that, the sequence conversion device creates a simplified sequence, like that in accordance with Embodiment 3.

Although the sequence conversion device in accordance with Embodiment 3 notifies conditional branch information to the conditioning unit 12 and follows an input of a condition made by the user, the update management unit 15a in accordance with this embodiment can extract “variable a≠1” as a condition on which to refer to the sequence A in the input sequence shown in FIG. 5(a), notify the condition to the reconstruction unit 13b as condition setting information, and eliminate the user having to perform a condition setting operation, like that in accordance with Embodiment 5.

As mentioned above, in the sequence conversion device in accordance with Embodiment 6, the update management unit 15a for managing the update state of a sequence, and, when there is an update in the sequence, sending condition setting information which the update management unit generates from a difference caused by the update and, when the sequence updated is a sequence to be referred to, also outputs a sequence which refers to the sequence to be referred to as related sequence information is disposed, and the analysis unit 11b outputs reference information according to the related sequence information, and the reconstruction unit 13b reconstructs sequence data according to the reference information and the condition setting information. Therefore, in the testing stage of a communication apparatus and communication processes performed by software, the sequence conversion device can keep the user from missing checking to see whether the communication apparatus and the software operate according to the changed sequence.

### Embodiment 7

FIG. 10 is a block diagram showing a sequence conversion device if in accordance with Embodiment 7. The sequence conversion device if in accordance with Embodiment 7 differs from the sequence conversion device in accordance with Embodiment 6 shown in FIG. 9 in that the sequence conversion device has a history unit 14 in a condition setting unit 12b, and a notification of condition setting information to an update management unit 15b is newly added. The update management unit 15b is constructed in such a way as to refer to the history unit 14 before outputting related sequence information, and, only when condition setting information shows a condition setting which refers to a sequence to be referred to, output related sequence information. The other components of the sequence conversion device are the same as those in accordance with Embodiment 6.

Next, the operation of the sequence conversion device if in accordance with Embodiment 7 will be explained.

When a sequence updated is a sequence to be referred to, the update management unit 15b acquires information showing on what kind of condition the sequence is referred to as well. In this case, only when determining that the sequence to be referred is referred to even on the above-mentioned condition as a result of a comparison of the condition with condition setting information acquired from the history unit 14, the update management unit notifies the sequence to an analysis unit 11b as related sequence information.

For example, when a sequence A shown in FIG. 5(b) is updated in a recording unit 10, the update management unit acquires both an input sequence shown in FIG. 5(a) which refers to the sequence, and “variable a≠1” which is a condition for the reference, and, only when acquiring the same condition “variable a≠1” from the history unit 14, notifies the input sequence shown in FIG. 5 (a) to the analysis unit 11b as related sequence information. After that, the sequence conversion device creates a simplified sequence, like that in accordance with Embodiment 3.

Thus, when a sequence to be referred to is updated, the sequence conversion device in accordance with Embodiment 7 can output only a sequence having a high degree of necessity for which a condition setting has been made previously.

As mentioned above, in the sequence conversion device in accordance with this Embodiment 7, the history unit 14 for storing condition setting information from the condition setting unit 12b, and the update management unit 15b for managing the update state of a sequence, and, when there is an update in the sequence, sending condition setting information which the update management unit generates from a difference caused by the update and, only when the sequence updated is a sequence to be referred to and the sequence to be referred to is referred to in a case in which condition setting information existing in the history unit 14 is applied, also outputting a sequence which refers to the sequence to be referred to as related sequence information are disposed, and the analysis unit 11b outputs reference information according to the related sequence information, and the reconstruction unit 13b reconstructs sequence data according to the reference information and condition setting information outputted from the update management unit 15b. Therefore, the sequence conversion device can prevent itself from redundantly outputting a sequence having a low degree of necessity.

### INDUSTRIAL APPLICABILITY

As mentioned above, the sequence conversion device in accordance with the present invention is constructed in such a way as to prevent increase in complexity due to conditional branches appearing in a sequence, references to other sequence diagrams, etc., the sequence conversion device in accordance with the present invention is suitable for checking to see whether a communication apparatus used with being connected to a network and software in which a plurality of communication processes run asynchronously operate according to the sequence.

1. A sequence conversion device comprising:
an analysis unit for extracting conditions for branching in a sequence from sequence data;
a condition setting unit for presenting a result of the condition extraction performed by said analysis unit and accepting a condition setting which a user inputs in response to the presentation of the condition extraction results, and for outputting a description of the condition setting as condition setting information; and
a reconstruction unit for reconstructing and outputting said sequence data according to the condition setting information from said condition setting unit.

2. A sequence conversion device comprising:
an analysis unit for extracting conditions for branching in a sequence from sequence data;
a condition setting unit for outputting, as plural pieces of condition setting information, descriptions of a plurality of condition settings in a case of making a conditional branch according to a result of the condition extraction performed by said analysis unit; and
a reconstruction unit for reconstructing and outputting said sequence data according to the plural pieces of condition setting information from said condition setting unit.

3. The sequence conversion device according to claim 1, wherein when a sequence to be referred to is included in the sequence, the analysis unit outputs reference information showing that said sequence includes said sequence to be referred to, and the reconstruction unit reconstructs the sequence data according to said reference information.

4. The sequence conversion device according to claim 1, wherein said sequence conversion device includes a history unit for storing condition setting results for a result of extraction of conditions for an arbitrary sequence, and the condition setting unit refers to said history unit when receiving a result of extraction of conditions for a specific sequence from the analysis unit, and, when condition setting results for said specific sequence are recorded in said history unit, presents descriptions of said recorded condition setting results.

5. The sequence conversion device according to claim 1, wherein said sequence conversion device includes a history unit for storing the condition setting information from the condition setting unit, and, when receiving specific condition setting information from said condition setting unit, the reconstruction unit refers to said history unit to determine whether said history unit has condition setting information matching said specific condition setting information, and reconstructs sequence data corresponding to said specific condition setting information only when said history unit does not have any condition setting information matching said specific condition setting information.

6. The sequence conversion device according to claim 1, wherein said sequence conversion device includes an update management unit for managing an update state of the sequence, and for, when there is an update in the sequence, sending condition setting information caused by a difference caused by the update, and said reconstruction unit reconstructs the sequence data according to said condition setting information.

7. The sequence conversion device according to claim 1, wherein said sequence conversion device includes an update management unit for managing an update state of the sequence, and for, when there is an update in the sequence, sending condition setting information caused by a difference caused by the update, and for, when the sequence updated is a sequence to be referred to, outputting a sequence which refers to said sequence to be referred to as related sequence information, and wherein the analysis unit outputs reference information according to said related sequence information and the reconstruction unit reconstructs the sequence data according to said reference information and said condition setting information.

8. The sequence conversion device according to claim 1, wherein said sequence conversion device includes a history unit for storing the condition setting information from the condition setting unit, and an update management unit for managing an update state of the sequence, and for, when there is an update in the sequence, sending condition setting information caused by a difference caused by the update, and for, only when the sequence updated is a sequence to be referred to and said sequence to be referred to is referred to in a case in which condition setting information existing in said history unit is applied, outputting a sequence which refers to said sequence to be referred to as related sequence information, and wherein the analysis unit outputs reference information according to said related sequence information and the reconstruction unit reconstructs the sequence data according to said reference information and the condition setting information outputted from said update management unit.
